(19) United States
(12) Patent Application Publication
(10) Pub. No.: US 2006/0250091 A1
(43) Pub. Date: Nov. 9, 2006

(54) Lighting circuit for light-emitting diode and control method thereof

(75) Inventor: Takuya Ishida, Tokyo (JP)

Correspondence Address: OSHA LIANG L.L.P., 1221 MCKINNEY STREET, SUITE 2800, HOUSTON, TX, 77010, US

(73) Assignee: Funai Electric Co., Ltd., Daito-shi (JP)

(21) Appl. No.: 11/270,321

(22) Filed: Nov. 9, 2005

(30) Foreign Application Priority Data
Nov. 9, 2004 (JP) 2004-324925

(51) Int. Cl. H05B 37/00

(52) U.S. Cl. 315/86

(57) ABSTRACT

A positive power voltage is supplied to a power line. When a high signal is applied to an input terminal, a transistor, which is a switching element, becomes the ON state, and a current flow only to a light-emitting diode, and thus only the light-emitting diode is lighted. When a low signal is applied to the input terminal, the transistor becomes the OFF state, and current flows to the light-emitting diodes. Since the values of the resistors are determined so that the current flowing to the light-emitting diode becomes sufficiently low, only the light-emitting diode is lighted. The light-emitting-diodes are serially connected in order not to receive an affect of the characteristics of the transistor.

### BACKGROUND OF THE INVENTION

1. Field of the Invention

The present invention relates to a lighting circuit for lighting two light-emitting diodes and a control method of the lighting circuit.

2. Description of the Related Art

Recently, a number of light-emitting diodes are used to display the operating status of electronic appliances, etc. Therefore, to lower the costs of electronic appliances, and to simplify the lighting circuits of the light-emitting diodes is needed. Here, as shown in FIG. 3, it has been proposed to selectively light two light-emitting diodes L51 and L52 with a single transistor Q51 (for example, JP-A-58-99031 (from line 20 in upper-right column, page 2, to line 4 in upper-left column, page 3) ). In the drawing, reference numeral 55 is a power terminal to which a positive voltage is provided, reference numeral 54 is a switch, reference numeral 53 is a bias circuit, and reference numerals R51 and R52 are resistors. The circuit operates as follows. When the switch 54 is off, the transistor Q51 becomes an OFF state, and a current does not flow to the light-emitting diode L51 but flows to the light-emitting diode L52, and thus only the light-emitting diode L52 is lighted. When the switch 54 is on, since a base current is supplied from the bias circuit 53 and the transistor Q51 becomes an ON state, a current flows to the light-emitting diodes L51 and L52. Here, the current flowing to the light-emitting diode L52 is made sufficiently small so that only the light-emitting diode L51 is lighted. JP-A-8-202307 (abstract and paragraphs [0002] to [0009]) mentioned below discloses, instead of simplifying the lighting circuit for the light-emitting diodes, the lighting circuit for the light-emitting diodes using a voltage boosting coil so that the light-emitting diodes can be lighted even if the power voltage is low.

Although not specifically disclosed in JP-A-58-99031, if the voltage of the power terminal 55 is denoted as Vcc, and the forward voltage of each of the light-emitting diodes L51 and L52 is denoted as Vf, the current IIL52, which flows to the light-emitting diode L52 when the transistor Q51 is in the OFF state, is denoted as Equation (1).
IIL52=(Vcc−Vf)/(R51+R52) (1)

Also, if the collector-emitter voltage when the transistor Q51 is in the ON state is denoted as Von, the current IR51 that flows to the resistor R51, the current IL52 that flows to the light-emitting diode L52, and the current IL51 that flows to the light-emitting diode L51 when the transistor Q51 is in the ON state, are shown as the following Equations (2) to (4), respectively.
IR51=(Vcc−Vf−Von)/R51 (2)
IL52=(Vf+Von−Vf)/R52=Von/R52 (3)
IL51=IR51−LI52 (4)

### SUMMARY OF THE INVENTION

However, according to the related technologies, since the two light-emitting diodes L51 and L52 are connected in parallel, the forward voltages Vf of the light-emitting diodes L51 and L52 cancel out each other as shown in Equation (3), and the current IL52 depends on the voltage Von. Therefore, if there is a fluctuation in the characteristics of the transistor Q51, the current IL52 varies greatly, and the current IL51 varies accordingly. Therefore, the light-emitting diode L51 is not lighted with the predetermined brightness, which is problematic.

It is an object of the present invention to provide a lighting circuit of light-emitting diode which is capable of selectively lighting two light-emitting diodes by a single switching element with a predetermined brightness while not being affected by the characteristics of the switching element and a control method of the lighting circuit.

According to an aspect of the invention, a control method of a lighting circuit for a light-emitting diode, the lighting circuit including: a first light-emitting diode whose cathode is grounded; a serial circuit of a second light-emitting diode and a second resistor, one end of the serial circuit being connected to an anode of the first light-emitting diode, the other end of the serial circuit being connected to a positive voltage line of a power, and the cathode of the second light-emitting diode being disposed at the first light-emitting diode side; and a transistor having: an emitter being grounded; a collector being connected to a connecting point of the first light-emitting diode and the serial circuit, and the collector being connected to the power line by a first resistor; and a base applying an on/off signal, the method including: turning the transistor off to light the first light-emitting diode; turning the transistor on to light the second light-emitting diode; and turning the transistor on/off having a period shorter than a predetermined period to make the first and the second light-emitting diodes in a visually lighted state together.

Here, in case the first power line is grounded and the second power line is supplied with a positive voltage, the first terminal of each of the first and the second light-emitting diodes is a cathode, and the second terminal is an anode. On the other hand, in case the first power line is grounded and the second power line is supplied with a negative voltage, the first terminal of each of the first and the second light-emitting diodes is the anode, and the second terminal is the cathode. As described above, since the first and the second light-emitting diodes are serially connected, and the forward voltages of the two light-emitting diodes do not cancel each other as in case the two light-emitting diodes are connected in parallel, i.e., since the current flowing to the switching element does not depend on the characteristics of the switching element, the first and the second light-emitting diodes can be selectively lighted with a predetermined brightness even when there is a fluctuation in the characteristics of the switching element.

According to another aspect of the invention, a lighting circuit for a light-emitting diode, including: a first light-emitting diode whose first terminal is connected to a first power line; a serial circuit having a second light-emitting diode and a second resistor, one end of the serial circuit being connected to a second terminal of the first light-emitting diode, the other end of the serial circuit being connected to a second power line, and the first terminal of the second light-emitting diode being disposed at a first light-emitting diode side; and a switching element having; a first terminal being connected to a first power line; a second terminal being connected to a connecting point of the first light-emitting diode and the serial circuit, and the second terminal being connected to a second power line by a first resistor, and a control terminal applying a signal that turns on/off between the first terminal and the second terminal.

According to another aspect of the invention, a control method of a lighting circuit for a light-emitting diode according to the above-aspect, the method including: turning the switching element off to light the first light-emitting diode; turning the switching element on to light the second light-emitting diode; and turning the switching element on/off with a period shorter than a predetermined period to make the first and the second light-emitting diodes in a visually lighted state together.

As described above, since the first and the second light-emitting diodes are serially connected, and the forward voltages of the two light-emitting diodes are not cancelled as in the case the two light-emitting diodes are connected in parallel, i.e., since the current flowing to the light-emitting diode does not depend on the characteristics of the transistor, the first and the second light-emitting diodes can be selectively lighted with a predetermined brightness even when there is a fluctuation in the characteristics of the transistor. Moreover, by turning the transistor on/off having a period shorter than a predetermined period as described above, the first and the second light-emitting diodes are selectively (alternately) lighted electrically. Because of the after-image effect, however, the first and the second light-emitting diodes visually appear to be lighted together. By doing so, without increasing the parts of the lighting circuit, i.e., with a single transistor and two light-emitting diodes, three types of lighting states can be implemented.

According to the above-aspects of the invention, since the first and the second light-emitting diodes are serially connected, the first and the second light-emitting diodes can be selectively lighted with a predetermined brightness even when there is a fluctuation in the characteristics of the switching element.

### BRIEF DESCRIPTION OF THE DRAWINGS

FIG. 1 is a drawing showing the lighting circuit for the light-emitting diodes according to an embodiment of the invention.

FIG. 2 is a drawing showing a lighting circuit for the light-emitting diode according to another embodiment of the invention.

FIG. 3 is a drawing showing a lighting circuit for the light-emitting diode according to a related art.

### DESCRIPTION OF THE PREFERRED EMBODIMENTS

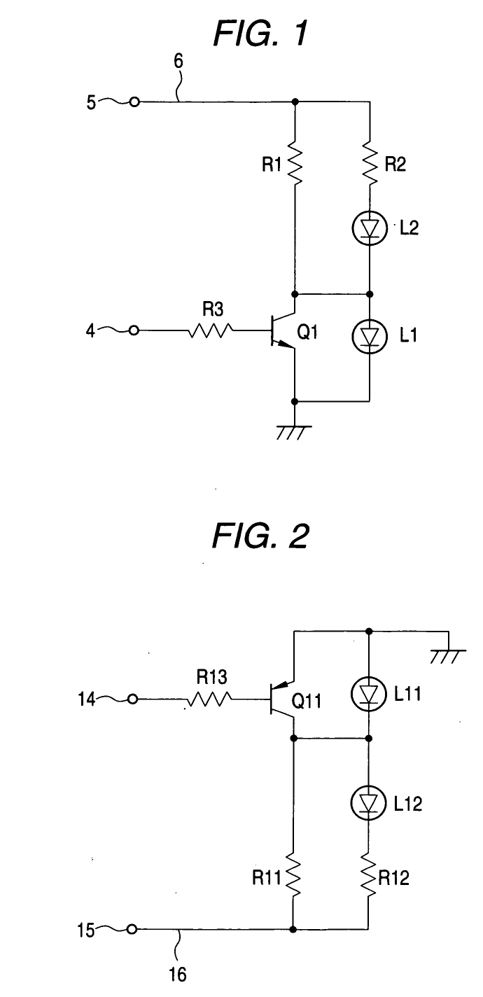

FIG. 1 is a drawing showing the lighting circuit for the light-emitting diodes according to the present invention. In the drawing, reference numeral 4 denotes an input terminal to which a signal that turns the transistor Q1 on/off is inputted, reference numeral 5 denotes a power terminal to which a power voltage Vcc (for example, a power voltage having a range about from 2.5 V to 5 V), and reference numeral 6 denotes a power line. A light-emitting diode L1, a light-emitting diode L2, and a resistor R2 are serially connected between the ground and the power line 6. The cathode of the light-emitting diode L1 is grounded, and the anode is connected to the cathode of the light-emitting diode L2. In other words, the cathode of the light-emitting diode L2 is disposed at the light-emitting diode L1 side so that the light-emitting diodes L1 and L2 have the same orientation. The emitter of the NPN-type transistor Q1 is grounded. The collector is connected to the connecting point of the light-emitting diode L1 and the serial circuit of the light-emitting diode L2 and the resistor R2, and is also connected to the power line 6 by a resistor R1. The base is connected to the input terminal 4 by a resistor R3.

Next, the operation of the lighting circuit for the light-emitting diodes will be described. A high signal (positive voltage signal) or a low signal (0 V signal) outputted from a control circuit, which is not shown, is applied to the input terminal 4. When the signal from the input terminal 4 is a high signal, a current flow to the base of the transistor Q1 through the resistor R3, and the transistor Q1 becomes the ON state. When the transistor Q1 is in the ON state, since the voltage Von between the collector and the emitter (generally, about 0.2 V) is lower than the forward voltage Vf of the light-emitting diode L1 (generally, about 1.5 V), the current supplied from the power line 6 flows into the transistor Q1 through the light-emitting diode L2, and only the light-emitting diode L2 is lighted. The current IIL2 that flows to the light-emitting diode L2 is shown in following Equation (5).
II_{L2}=(Vcc−Vf−Von)/R2 (5)

As described above, since Von is sufficiently lower than Vf, the current IIL2 can be approximated in the following Equation (5a).
II_{L2}=(Vcc−Vf)/R2 (5a)

When the signal from the input terminal 4 is a low signal, no current flows into the base of the transistor Q1, and the transistor Q1 becomes the OFF state, and the collector voltage of the transistor Q1 becomes the forward voltage Vf of the light-emitting diode L1. As a result, the current supplied from the power line 6 flows to the route passing the resistor R1 and the light-emitting diode L1, and on the route passing the resistor R2 and the light-emitting diode L2 and L1. The current IR1 flowing to the resistor R1, the current IL2 flowing to the diode L2, and the current IL1 flowing to the light-emitting diode L1 are represented by the following Equations (6) to (8), respectively. Here, the forward voltage of each of the light-emitting diodes L1 and L2 is assumed to be Vf, respectively.
IR1=(Vcc−Vf)/R1 (6)
I_{L2}=(Vcc−2Vf)/R2 (7)
I_{L1}=I_{R1}+I_{L2} (8)

In the circuit in FIG. 1, since the resistance values of the resistors R1 and R2 (hereinafter, also referred to as the “resistance value R1”, and the “resistance value R2”, respectively) are determined, considering the power voltage Vcc, the forward voltage Vf and the forward voltage-current characteristics of the light-emitting diodes L1 and L2, etc., so that the light-emitting diode L2 is not lighted, i.e., the current IL2 flowing to the light-emitting diode L2 is sufficiently small so only the light-emitting diode L1 is lighted. On the other hand, since it is desirable that the brightness of the light-emitting diodes L1 and L2 be equal to each other, the resistance values R1 and R2 are also determined so that the current IL1 flowing to the light-emitting diode L1 when the transistor Q1 is in the OFF state, and the current IIL2 flowing to the light-emitting diode L2 when the transistor Q1 is in the ON state are equal to each other. When the high or the low signal is thus applied to the input terminal 4, the light-emitting diodes L1 and L2 are selectively lighted. As is noted from Equations (5a) and (6) above, the precondition of the embodiment is that the power voltage Vcc is higher than the forward voltage Vf of each of the light-emitting diodes L1 and L2.

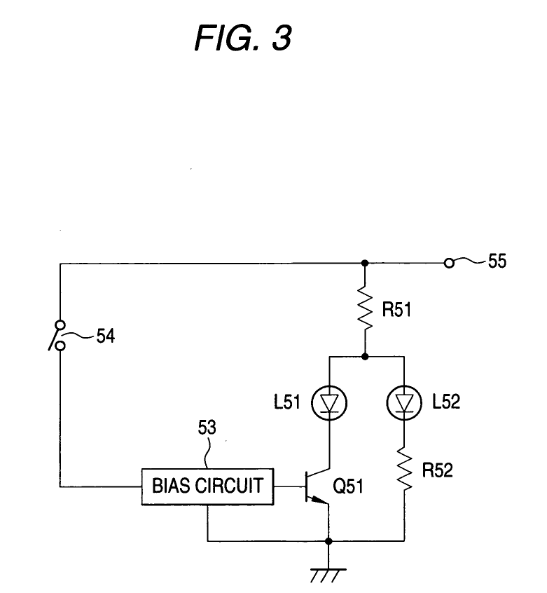

According to the embodiment, since the light-emitting diode L1 and the light-emitting diode L2 are serially connected, and thus the forward voltages Vf of the light-emitting diodes L51 and L52 (FIG. 3) connected in parallel are not cancelled (Equation (3)) as in the related art, i.e., since the above-mentioned current IL1, etc., does not depend solely on the collector-emitter voltage Von, even when there is a fluctuation in the characteristics of the transistor Q1, the two light-emitting diodes L1 and L2 can be selectively lighted with a predetermined brightness.

Also, as is noted from Equation (7), since the two light-emitting diodes L1 and L2 are serially connected, if the power voltage Vcc is lower than twice the forward voltage Vf of the light-emitting diodes L1 and L2, the current IL2 flowing to the light-emitting diode L2 when the transistor Q1 is in the OFF state becomes 0, and the current IL1 flowing to the light-emitting diode L1 becomes equal to the current IR1 flowing to the resistor R1. In other words, in the above-mentioned embodiment, since only the light-emitting diode L1 is lighted regardless of the resistor value R2, it is easy to determine the above-described resistor values R1 and R2. Moreover, since only R2 is connected to the light-emitting diode L2, Equations (5) to (8) become simpler than Equations (1) to (4) in case two resistors R51 and R52 are connected to the light-emitting diode L52 (FIG. 3). Accordingly, it is easy to determine the above-mentioned resistor values R1 and R2.

So far, it has been described as to how the light-emitting diodes L1 and L2 are selectively lighted. Hereinafter, another lighting method of the light-emitting diodes L1 and L2, i.e., another control method of the lighting circuit for the light-emitting diodes will be described. The control method is performed by applying a pulse signal that changes high/low with a frequency equal to or higher than a predetermined frequency to the input terminal 4, i.e., by turning the transistor Q1 on/off having a shorter period than a predetermined period. By doing so, although the light-emitting diodes L1 and L2 are alternately lighted electrically, the light-emitting diodes L1 and L2 visually appear to be lighted together, due to a residual image.

The lowest value of the predetermined frequency of the above-mentioned pulse signal is the frequency with which the light-emitting diodes L1 and L2 visually appear to be lighted together, for example, at 1 kHz. Since an excessively high frequency might generate a high frequency noise, for example, the highest value may be set to 300 kHz. In order for the light-emitting diodes L1 and L2 to visually appear to be lighted together, the ratio of the high portion and the low portion of the pulse signal is preferably one-to-one.

Although the NPN-type transistor Q1 is used in the embodiment, the embodiment may also be implemented using a PNP-type transistor by correspondingly changing the base-bias circuit. Instead of the transistor, a switching element such as an FET (Field Effect Transistor) may be used. Even though the forward voltages Vf of the light-emitting diodes L1 and L2 are the same in the above-described embodiment, the embodiment may also be implemented with different forward voltages.

Although the positive power voltage Vcc is supplied to the power line 6 in the embodiment, the embodiment may also be implemented by supplying a negative power voltage from the power terminal 15 to the power line 16 as shown in FIG. 2. Here, if a negative voltage signal is applied to the input terminal 14, a base current flows through the resistor R13, and the PNP-type transistor Q11 becomes the ON state, and thus only the light-emitting diode L12 is lighted. If a 0 V signal is applied to the input terminal 14, the transistor Q11 becomes the OFF state, and currents flow to the light-emitting diodes L11 and L12. However, since the resistance values R11 and R12 are determined so that the current flowing to the light-emitting diode L12 is sufficiently low, only the light-emitting diode L11 is lighted. It is noted that, even though the cathode of the light-emitting diode L1 is grounded in FIG. 1, since a positive power voltage is supplied to the power line 16 in FIG. 2, the anode of the light-emitting diode L11 is also grounded.

What is claimed is:

1. A control method of a lighting circuit for a light-emitting diode, the lighting circuit including: a first light-emitting diode whose cathode is grounded; a serial circuit of a second light-emitting diode and a second resistor, one end of the serial circuit being connected to an anode of the first light-emitting diode, the other end of the serial circuit being connected to a positive voltage line of a power, and the cathode of the second light-emitting diode being disposed at the first light-emitting diode side; and a transistor having: an emitter being grounded; a collector being connected to a connecting point of the first light-emitting diode and the serial circuit, and the collector being connected to the power line by a first resistor; and a base applying an on/off signal, the method comprising:
turning the transistor off to light the first light-emitting diode; turning the transistor on to light the second light-emitting diode; and
turning the transistor on/off having a period shorter than a predetermined period to make the first and the second light-emitting diodes in a visually lighted state together.

2. A lighting circuit for a light-emitting diode, comprising:
a first light-emitting diode whose first terminal is connected to a first power line;
a serial circuit having a second light-emitting diode and a second resistor, one end of the serial circuit being connected to a second terminal of the first light-emitting diode, the other end of the serial circuit being connected to a second power line, and the first terminal of the second light-emitting diode being disposed at a first light-emitting diode side; and
a switching element having;
a first terminal being connected to a first power line;
a second terminal being connected to a connecting point of the first light-emitting diode and the serial circuit; the second terminal being connected to a second power line by a first resistor, and
a control terminal applying a signal that turns on/off between the first terminal and the second terminal.

3. A control method of a lighting circuit for a light-emitting diode according to claim 2, the method comprising:
turning the switching element off to light the first light-emitting diode;
turning the switching element on to light the second light-emitting diode; and
turning the switching element on/off with a period shorter than a predetermined period to make the first and the second light-emitting diodes in a visually lighted state together.
